(19) United States
(12) Patent Application Publication
(10) Pub. No.: US 2019/0193344 A1
(43) Pub. Date: Jun. 27, 2019

(54) TOOL FOR USE IN CONSOLIDATION OF A FIBRE-REINFORCED COMPONENT

(71) Applicant: Airbus Operations GmbH, Hamburg (DE)

(72) Inventors: Claus Hanske, Hamburg (DE); Benjamin Leohold, Hamburg (DE); Remo Hinz, Hamburg (DE); Albrecht Kluge, Hamburg (DE)

(73) Assignee: Airbus Operations GmbH, Hamburg (DE)

(21) Appl. No.: 16/214,737

(22) Filed: Dec. 10, 2018

(30) Foreign Application Priority Data
Dec. 22, 2017 (DE) 10 2017 131 201.3

(51) Int. Cl. B29C 70/34; B29C 70/44; B29C 37/00; B29C 33/38

(52) U.S. Cl. CPC B29C 70/342; B29C 33/38; B29C 37/005; B29C 70/446

(57) ABSTRACT

A tool for use in consolidation of a fibre-reinforced component has an outer casing supported by an internal structure. The outer casing has a first contact surface, which is provided for the purpose of resting flat against the component during the consolidation of the component and predetermining a shape of the component in some section or sections. The internal structure and the outer casing are configured in such a way that, when the tool is heated from an initial temperature to a consolidation temperature required for the consolidation of the component, the tool expands in such a way perpendicularly to the first contact surface that a defined first pressure is exerted on the component by the first contact surface. The use of a component of this kind is furthermore claimed and described.

### FIELD OF THE INVENTION

The present invention relates to a tool for use in consolidation of a fibre-reinforced component. The invention furthermore relates to the use of a tool of this kind.

### BACKGROUND OF THE INVENTION

Fibre-reinforced components are components composed of fibre composite materials. The latter generally consist of two main components: a matrix and reinforcing fibres embedded in the matrix. In aircraft construction the use of carbon fibres embedded in a matrix composed of resin is common, for example. In order to cure a component composed of a fibre composite material, it is simultaneously subjected to heat and pressure. Depending on the type of material, the heat cures the resin (resins or matrixes composed of thermosetting plastics or thermosetting polymers, referred to below for short as thermoset matrixes) or heats it up in such a way that it can be consolidated (resins or matrixes composed of thermoplastic materials, referred to below for short as thermoplastic matrixes), while the compaction can be set by means of the pressure (thermoset and thermoplastic matrixes). Compaction, in turn, affects the internal quality of the component (e.g. resin distribution, fibre volume content, air inclusions, displacement or undulations in the fibre orientation). Since the strength and stiffness properties of the finished component depend decisively on the fibre/resin ratio, and the air inclusions have a negative effect on the strength and stiffness properties, the pressure must be precisely controlled. In the case of the known fibre composite components comprising thermosetting plastic resins (thermoset matrixes), the pressure can be produced inter alia by the thermal expansion of the moulding tools (e.g. pressure cores) by means of which the shape of the components is predetermined.

In some cases, wide-ranging use of fibre-reinforced components is currently prevented by the high costs of the components. Among the ways of reducing the costs of the components is to use matrixes composed of more advantageous thermoplastic materials. However, the processing of such matrixes is made more difficult by the fact that the thermoplastic matrixes can be moulded and consolidated only at significantly higher temperatures than the temperatures at which thermoset matrixes cure. For example, currently used thermosetting plastic resins already cure at a temperature of about 120° C.-180° C., while suitable thermoplastic materials can be moulded and processed only at a consolidation temperature of about 340° C.-400° C.

Owing to the higher consolidation temperature, the methods which have previously been used for components comprising thermoset matrixes can therefore only be adopted to a limited extent for components comprising thermoplastic matrixes. In particular, many materials for moulding tools which are used with fibre-reinforced components comprising thermoset matrixes cannot be used in the consolidation of fibre-reinforced components comprising thermoplastic matrixes. This is because, when the moulding tools are heated not to 180° C. but to 400° C., they expand much more, depending on the material. This can lead to excessive compression in the component and also to damage to the production equipment.

### BRIEF SUMMARY OF THE INVENTION

An aspect of the present invention may provide tools or cores which can be used in the consolidation of fibre-reinforced components and, preferably, of fibre-reinforced components comprising matrixes composed of thermoplastic materials.

A first aspect relates to a tool for use in consolidation of a fibre-reinforced component. The fibre-reinforced component preferably has a matrix composed of a thermoplastic material, which is also referred to as a thermoplastic matrix. However, the tool can also be used in the production of a fibre-reinforced component comprising matrixes composed of thermosetting plastics or thermosetting polymers. Such matrixes are referred to below as thermoset matrixes. The tool has an outer shell, which is supported by an internal structure. The outer shell has a first contact surface, which is provided for the purpose of resting flat against the component during the consolidation of the component and predetermining a shape of the component, at least in some section or sections. The internal structure and the outer shell are configured in such a way that, when the tool is heated from an initial temperature to a consolidation temperature required for the consolidation of the component, the tool expands in such a way perpendicularly to the first contact surface that a defined first pressure is exerted on the component by the first contact surface.

The tool according to an embodiment of the invention, which is also referred to as a core or a pressure core, comprises an outer shell or casing and an internal structure. The outer shell can be partially or completely closed. In other words, it surrounds the internal structure in the form of a housing. However, it is not necessarily completely closed, i.e. it can also have openings. The internal structure is arranged within the housing formed by the outer shell. Moreover, the internal structure is provided for the purpose of supporting the outer shell, that is to say for the purpose of accepting and distributing loads acting on the shell.

Part of the outer shell forms a first contact surface. When the tool is used in the consolidation of a fibre-reinforced component, this surface is used to shape the component, at least in some section or sections, and to exert pressure on the component by the tool. A tool can have one or more contact surfaces.

Finally, the outer casing and the internal structure of the tool are configured in such a way that, during consolidation, the tool expands in the direction of the first contact surface by an amount precisely sufficient to ensure that the pressure required to consolidate the component is exerted on the fibre-reinforced component. Depending on the material used for the matrix of the fibre-reinforced component, either the curing temperature (thermoset matrixes) or the temperature at which the matrix can be consolidated (thermoplastic matrixes) is referred to as the consolidation temperature. Since the temperature difference between the initial temperature, e.g. room temperature, and the consolidation temperature of the respective component cannot be changed, the invention envisages adapting the internal structure and the outer shell of the component in such a way that the tool does not expand more than necessary when heated to the consolidation temperature in order to ensure that the pressure exerted on the component is not excessive. However, the internal structure and the outer shell are also chosen so that the tool expands enough to exert a sufficiently high pressure on the component.

In particular, the expansion of the tool can be controlled via the configuration of the internal structure of the tool. In this case, the initial assumption is fundamentally that a more massive tool expands more and hence also produces a higher pressure. The less pressure is required, the lighter the component can be. In order nevertheless to ensure adequate stability, the internal structure can be of honeycomb or lattice-type design, for example. Complex structures are also conceivable.

The internal structure is preferably formed, at least in some section or sections, by different materials with different thermal expansion coefficients, such that the expansion of the tool perpendicularly to the first contact surface when the tool is heated from the initial temperature to the consolidation temperature depends on the different materials of the internal structure.

For example, some section or sections of the structure can be formed from a material with a high thermal expansion coefficient and some section or sections from a material with a low thermal expansion coefficient. By means of the ratio of the two materials in the internal structure, the expansion of the internal structure and hence the pressure exerted by the tool on the component can be controlled. Since the internal structure has a large dimension in relation to the thickness of the outer casing, perpendicularly to the first contact surface, it is possible, in particular, to adjust the magnitude of the pressure via the choice of proportions of suitable materials.

As an alternative or in addition, it is preferred if, in the region of the first contact surface, the outer casing is formed from a plurality of layers, which extend parallel to the contact surface, wherein at least two of the plurality of layers are formed from different materials, which have different thermal expansion coefficients, with the result that the expansion of the tool perpendicularly to the first contact surface when the tool is heated from the initial temperature to the consolidation temperature depends on the different materials of the outer casing and on a thickness of the layer perpendicularly to the first contact surface.

This has the advantage that the expansion of the tool can be modified directly in the casing and is suitable, in particular, for precisely setting the pressure since the thickness of the outer casing perpendicularly to the first contact surface is generally less than the dimensions of the internal structure. Moreover, the pressure can be set and varied over the entire contact surface.

In a preferred embodiment, the outer casing has a second contact surface, which is provided for the purpose of resting flat against the component during the consolidation of the component and predetermining a shape of the component in some section or sections, wherein the internal structure and the outer casing are configured in such a way that, when the tool is heated from the initial temperature to the consolidation temperature, the tool expands in such a way perpendicularly to the second contact surface that a defined second pressure is exerted on the component by the second contact surface, wherein the first pressure and the second pressure are different. It is likewise possible to provide more than two contact surfaces on the tool, each of which exerts a different pressure on the component when heated to the consolidation temperature.

In the preferred embodiment, the pressure exerted by the tool on the component can thus be set differently for two contact surfaces. Setting can preferably be accomplished by means of the construction and configuration of the internal structure. In particular, this makes it possible to produce different pressures in a component by means of a core or tool. It is thereby possible to subject different regions of a component to different loads but also to make them of different densities, resulting in a decrease in the overall weight of the component since it is no longer the most robust section of the component which determines the pressure.

In the region of the first contact surface, the outer casing preferably has a thickness perpendicularly to the first contact surface which differs from a thickness of the outer shell perpendicularly to the second contact surface in the region of the second contact surface, with the result that, owing to the different thickness of the outer shell in the region of the first and the second contact surface, the tool expands to a different extent perpendicularly to the first contact surface than perpendicularly to the second contact surface when heated from the initial temperature to the consolidation temperature. In this case, the expansion of the tool parallel to that contact surface of the first and the second contact surface which has a lower thickness can preferably be blocked with less effort than the expansion of the tool parallel to that contact surface of the first and the second contact surface which has a greater thickness.

As an alternative or in addition to the design of the internal structure, it is thus also possible to make the first and second contact surface differ in thickness. With otherwise identical materials (or material blends), the thermal expansion and hence pressure can be controlled by way of the thickness of the casing.

It is furthermore preferred if the internal structure is formed from different materials with different thermal expansion coefficients, with the result that, owing to the materials with different thermal expansion coefficients, the tool expands to a different extent perpendicularly to the first contact surface than perpendicularly to the second contact surface when heated from the initial temperature to the consolidation temperature. It is likewise possible for some section or sections of the internal structure to be formed from materials with different thermal expansion coefficients and thus to control the pressure which is exerted by the different contact surfaces.

In a preferred embodiment, the internal structure and/or the outer shell have been produced by a generative production method. The tool or at least part of the tool can be produced by a 3-D printing method, for example.

A second aspect relates to the use of a tool according to one of the preceding embodiments in consolidation of a fibre-reinforced component. The tool is preferably used in the consolidation of a fibre-reinforced component comprising a matrix of a thermoplastic material. The advantages of the use according to aspects of the invention correspond to the advantages of the tool used.

### BRIEF DESCRIPTION OF THE DRAWINGS

The present invention is explained in greater detail below by means of the figures showing an embodiment example, wherein

FIG. 1a shows a plurality of tools according to various embodiments of the invention,

FIG. 1b shows a plurality of tools according to various embodiments of the invention which are used to consolidate a fibre-reinforced component,

FIG. 1c shows a fibre-reinforced component produced using the tools in FIG. 1b,

FIGS. 2a to 2d show sectional views of tools according to various embodiments of the invention, and

FIGS. 3a to 3c show illustrative embodiments of internal structures for tools according to various embodiments of the invention.

### DETAILED DESCRIPTION

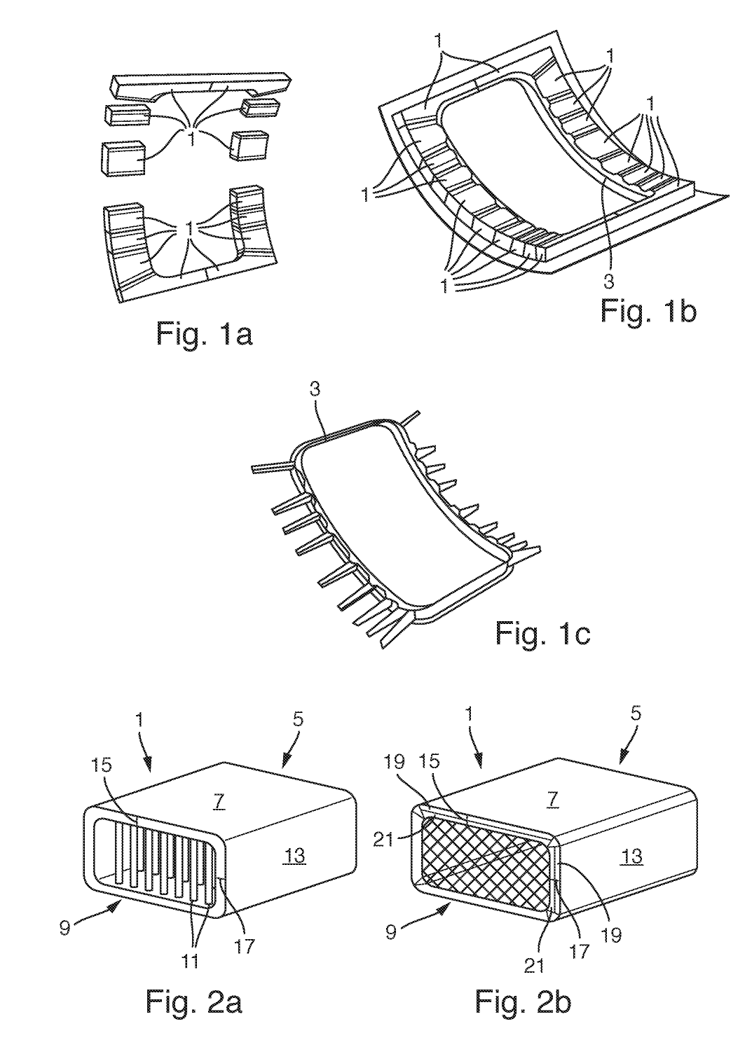

FIG. 1a shows a plurality of illustrative embodiments of tools or cores 1 which can be used in the consolidation of a fibre-reinforced component, that is to say a component composed of a fibre composite material. In all the figures, identical elements are denoted by the same reference signs.

The use of the tools 1 from FIG. 1a and of a plurality of additional tools 1 in the consolidation of the component 3 composed of a fibre composite material is shown in FIG. 1b. The fibre composite material is formed from a matrix, in which reinforcing fibres are embedded. In the example illustrated in FIG. 3, the matrix is formed from a thermoplastic which can be consolidated at a temperature of 400° C., for example. In the present context, a matrix of this kind is also referred to as a thermoplastic matrix.

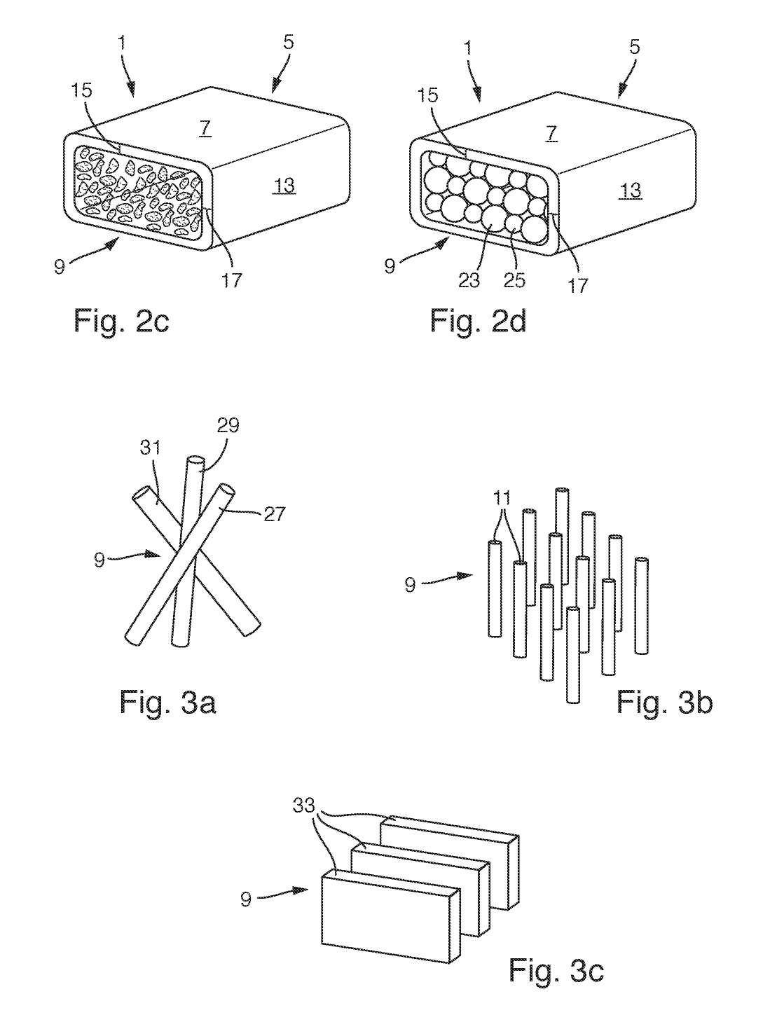

The tools 1 each have at least one first contact surface, by means of which they rest against the component to be consolidated. The details of the construction of the tools are described in greater detail below with reference to FIGS. 2a to 2d and 3a to 3c, in which illustrative embodiments of tools according to the invention and illustrative internal structures are shown.

Finally, in FIG. 1c, the component 3 from FIG. 1b is shown after consolidation. The illustrative component 3 is a reinforcement for a door opening in an aircraft fuselage.

FIGS. 2a to 2d show sectional views of four different embodiments of a tool 1, which are each provided for use in the consolidation of a component composed of a fibre composite material having a thermoplastic matrix. In principle, however, the tools 1 can also be used in the consolidation of a component composed of a fibre composite material having a thermoset matrix.

The tool 1 shown in FIG. 2a comprises an outer casing 5, which is also referred to as an outer shell 5. The outer casing 5 has a first contact surface 7. During the consolidation of a component composed of a fibre composite material, the first contact surface 7 rests flat against the component and predetermines the shape of the component, at least in some section or sections. In other words, the external shape of the component is at least partially adjusted to the shape of the first contact surface 7 during consolidation.

The outer casing 5 forms a housing, in which an internal structure 9 is arranged. In the embodiment example illustrated in FIG. 2a, the internal structure 9 is formed by a multiplicity of cylindrical round bars 11 extending parallel to one another. Of the round bars 11 shown in FIG. 2a, only two have been denoted with the reference sign 11 in order to avoid making the embodiment excessively difficult to recognize in the illustration. The round bars 11 extend substantially perpendicularly to the first contact surface 7. The internal structure 9 of the tool 1 in FIG. 2a is configured in such a way that, when the tool 1 is heated from room temperature as an illustrative initial temperature to a consolidation temperature of, for example, 400° C., it expands primarily perpendicularly to the first contact surface 7. It is thereby possible to exert a defined first pressure on the component or the section of the component which rests against the first contact surface 7. By virtue of the configuration of the internal structure 9 and, in particular, by virtue of the use of an internal structure 9 which extends substantially perpendicularly to the first contact surface 7, pressure is exerted primarily in the direction of the first contact surface 7.

In addition to the first contact surface 7, the tool 1 furthermore has a second contact surface 13, which is likewise provided for contact with a section of the component to be consolidated. As can be seen in FIG. 2a, the outer casing 5 has a greater 15 thickness in the region of the first contact surface 7, perpendicularly to the contact surface 7, than in the region of the second contact surface 13, where the outer casing 5 conversely has a lesser thickness 17. The tool 1 is thus designed to exert a greater pressure on a component to be consolidated via the first contact surface 7 than via the second contact surface 13. It is not only by virtue of the internal structure 9 that the tool 1 expands more perpendicularly to the first contact surface 7 than perpendicularly to the second contact surface 13 but also by virtue of the greater thickness 15 in the region of the first contact surface 7. Conversely, the thinner outer casing 5 in the region of the second contact surface 13 has the effect that, when heated to the consolidation temperature, the second contact surface 13 exerts significantly less pressure on the component than the first contact surface 7.

The embodiment shown in FIG. 2a thus has the advantage that the pressure exerted by the first contact surface 7 can be precisely set by means of the internal structure 9 and that, by virtue of the internal structure 9 and the different thicknesses 15, 17 of the outer casing 5 in the region of the respective contact surfaces 7, different pressures are likewise exerted via the first and the second contact surface.

FIG. 2b shows a second example of a tool 1 according to an embodiment of the present invention. This tool 1 too comprises an outer casing 5 and an internal structure 9. Like the embodiment example illustrated in FIG. 2a, the tool 1 from FIG. 2b has, in addition to the first contact surface 7, a second contact surface 13, which is likewise provided for the purpose of resting against a section of a component to be consolidated composed of a fibre composite material. Both in the region of the first contact surface 7 and in the region of the second contact surface 13, the outer casing 5 comprises two layers 19, 21 composed of materials with different thermal expansion coefficients. For example, the material of the first layer 19 has a higher thermal expansion coefficient than the material of the second layer 21. However, the outer casing 5 differs in the region of the first and the second contact surface 7, 13 in the proportion of the thickness 15, 17 of the outer casing 5 which is occupied by the first and the second layer 19, 21. By means of the different proportions of the materials with different thermal expansion coefficients, the expansion of the outer casing 5 and hence the pressure exerted by the respective contact surfaces 7, 13 can be set in an advantageous manner.

The internal structure 9 of the embodiment example illustrated in FIG. 2b is grid-like and ensures uniform distribution of the pressure on the component to be consolidated via the first and the second contact surface 7, 13.

Another example of a tool 1 according to an embodiment of the invention is illustrated in FIG. 2c. This embodiment differs from the embodiment illustrated in FIG. 2a in the configuration of the internal structure 9. While, in FIG. 2a, a regular structure is used, the tool 1 in FIG. 2c comprises a bionic internal structure 9, by means of which more complex pressure distributions can be exerted on the component to be consolidated via the first contact surface 7 and the second contact surface 13 when the tool 1 is heated from an initial temperature to the consolidation temperature.

Finally, FIG. 2d illustrates a fourth example of a tool 1 according to an embodiment of the invention. This embodiment example likewise differs from the embodiments illustrated in FIGS. 2a and 2b in its internal structure 9. This comprises a ball packing with balls 23, 25, wherein the balls are either of a first ball type (balls 23) or of a second ball type (balls 25). In order to avoid making the embodiment more difficult to recognize in the illustration in FIG. 2b, only two of the balls 23, 25 of the internal structure 9—one of each ball type—are provided with reference signs.

The balls 23, 25 of the first and the second ball type differ, on the one hand, in the dimensions but, on the other hand, also in the material from which they are formed. For example, the balls 23 of the first ball type can be formed from a material with a higher thermal expansion coefficient than the balls 25 of the second ball type. In other words, the internal structure 9 of the tool 1 in FIG. 2d is formed from two different materials, wherein the two different materials each have different thermal expansion coefficients. By means of the arrangement of the balls 23, 25, it is possible to vary the pressure which is exerted on a component to be consolidated via the first contact surface 7 and the second contact surface 13. In particular, it is possible to exert a different pressure on the component via the first contact surface 7 than via the second contact surface 13 since the balls 23 of the first ball type expand to a different extent than the balls 25 of the second ball type when heated to the consolidation temperature.

Finally, three different examples of internal structures 9 of tools 1 are illustrated in FIGS. 3a, 3b and 3c, wherein the internal structures 9 can comprise the respective examples illustrated in multiple instances or only in part. FIG. 3a shows a first embodiment, in which the internal structure 9 has three crossed round bars 27, 29, 31. This embodiment has the advantage that pressure is built up primarily along the direction of extent of a central round bar 29 but, at the same time, pressure can also be produced perpendicularly to the direction of extent by sloping round bars 27, 31. By virtue of the slope of the sloping round bars 27, 31 relative to the central round bar 29, this pressure is lower, however.

FIG. 3b shows a segment of the internal structure 9 from FIG. 2a, in which a multiplicity of round bars 11 extend parallel to one another. Here too, only some of the round bars 11 are denoted by reference signs. By virtue of this internal structure 9, pressure is produced in only one direction.

Finally, FIG. 3c shows an embodiment in which the internal structure 9 comprises three cuboids 33 arranged parallel to one another. The cuboids 33 also expand when heated from the initial temperature to the consolidation temperature. Since the expansion depends in each case on the material thickness of the cuboids 33, different pressures can be exerted in three directions via this internal structure 9 on a component resting against corresponding contact surfaces.

The tools 1, including the internal structures 9 and the outer casings 5, are preferably produced by a generative layer build-up method, e.g. 3-D printing.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tool for use in consolidation of a fibre-reinforced component, comprising:
an outer casing supported by an internal structure,
wherein the outer casing has a first contact surface for resting flat against the component during the consolidation of the component and predetermining a shape of the component in some section or sections, and
wherein the internal structure and the outer casing are configured in such a way that, when the tool is heated from an initial temperature to a consolidation temperature required for the consolidation of the component, the tool expands in such a way perpendicularly to the first contact surface that a defined first pressure is exerted on the component by the first contact surface.

2. The tool according to claim 1, wherein the internal structure is formed, at least in some section or sections, by different materials with different thermal expansion coefficients, wherein the expansion of the tool perpendicularly to the first contact surface when the tool is heated from the initial temperature to the consolidation temperature depends on the different materials of the internal structure.

3. The tool according to claim 1, wherein, in the region of the first contact surface, the outer casing is formed from a plurality of layers extending parallel to the contact surface,
wherein at least two of the plurality of layers are formed from different materials having different thermal expansion coefficients, with the result that the expansion of the tool perpendicularly to the first contact surface when the tool is heated from the initial temperature to the consolidation temperature depends on the different materials of the outer casing and on a thickness of the layers perpendicularly to the first contact surface.

4. The tool according to claim 1, wherein the outer casing has a second contact surface for resting flat against the component during the consolidation of the component and predetermining a shape of the component in some section or sections,
wherein the internal structure and the outer casing are configured in such a way that, when the tool is heated from the initial temperature to the consolidation temperature, the tool expands in such a way perpendicularly to the second contact surface that a defined second pressure is exerted on the component by the second contact surface, wherein the first pressure and the second pressure are different.

5. The tool according to claim 4, wherein, in the region of the first contact surface, the outer casing has a thickness perpendicularly to the first contact surface which differs from a thickness of the outer casing perpendicularly to the second contact surface in the region of the second contact surface, with the result that, owing to the different thickness of the outer casing and the consequent different resultant force of the thermal expansion in the region of the first and the second contact surface, the tool expands to a different extent perpendicularly to the first contact surface than perpendicularly to the second contact surface when heated from the initial temperature to the consolidation temperature.

6. The tool according to claim 4, wherein the internal structure is formed from different materials with different thermal expansion coefficients, with the result that, owing to the materials with different thermal expansion coefficients, the tool expands to a different extent perpendicularly to the first contact surface than perpendicularly to the second contact surface when heated from the initial temperature to the consolidation temperature.

7. The tool according to claim 1, wherein the internal structure and/or the outer casing have been produced by a generative production method.

8. The tool according to claim 1, wherein the tool is configured for use in consolidation of a fibre-reinforced component comprising a matrix of a thermoplastic material.
